(19) United States
(12) Patent Application Publication
(10) Pub. No.: US 2011/0046992 A1
(43) Pub. Date: Feb. 24, 2011

(54) System and methods for management of external dependencies associated with a project portfolio

(76) Inventor: Itay M. Erhard, New York, NY (US)

Correspondence Address: Itay Erhard, Suite 11-D, 3 Sheridan Square, New York, NY, 10014, US

(21) Appl. No.: 12/805,869

(22) Filed: Aug. 23, 2010

Related U.S. Application Data
(60) Provisional application No. 61/236,101, filed on Aug. 23, 2009.

(51) Int. Cl. G06F 17/30

(52) U.S. Cl. 705/7

(57) ABSTRACT

The present invention applies concepts from the graph theory in mathematics and computer science to the management of external dependencies associated with a project portfolio. By viewing components of a project portfolio as nodes (vertices) of a graph, which may also include activities that are external to the project portfolio but depend or impose dependencies on it, a significant and unique business value can be realized. An exemplary embodiment of these concepts is described, demonstrating comprehensive, generic, and flexible system and methods.

### CROSS-REFERENCE TO RELATED PATENT APPLICATIONS

This patent application claims priority from and is related to U.S. Provisional Patent Application Ser. No. 61/236,101, filed Aug. 23, 2009, this U.S. Provisional Patent Application incorporated by reference in its entirety herein.

### FIELD OF INVENTION

The present invention generally relates to project portfolio management methods and inventions. More particularly, the present invention relates to methods and inventions for providing and maintaining external dependencies associated with a portfolio of projects.

### BACKGROUND OF THE INVENTION

External project dependencies, broadly defined by the Project Management Institute (PMI) as “non project activities which influence the project activities”, are considered one of the most complex aspects of project management and a primary reason for projects' failure. While prior art in the fields of Project Management (PM) and Project Portfolio Management (PPM) has addressed many aspects of intra-organizational cross-project or program dependencies, little attention has been accorded to the concept of external dependencies (EDs) in the broader project portfolio context and its intra or extra-organizational ecosystem.

PPM is both a framework and a management activity that has multiple interdependence relationships with other intra or extra-organizational activities. Work units of a project portfolio, referred to as portfolio components (PCs), ranging from the smallest work unit to the highest-level portfolio may depend on external activities (EAs) and impose EDs on other entities or, in other words, be involved in an external dependency relationship (EDR). EDRs associated with different types of PCs and scenarios tend to have a combination of unique management requirements, shared attributes, processes, and business rules. They often represent important intra and extra-organizational relationships, indicate business trends, consume expensive resources, and serve as primary organizational “bottlenecks”. Nevertheless, prior art has failed to propose consistent, flexible and comprehensive methods for management of EDRs associated with a project portfolio.

The absence of such methods impedes a number of primary PPM objectives, including alignment of project initiatives with organizational strategy, execution of the selected initiatives, and implementation of effective governance or control mechanisms for PPM activities.

Several specific challenges associated with methods in the prior art shall now be described.

A first outstanding challenge is PPM stakeholders' inability to use PPM methods to establish consistent rule-based associations between all data describing EDs—probabilistic or deterministic, hypothetical or concrete—and risk/benefit measures, ranking criteria, or complexity assessment criteria of PCs such as projects or programs. This missing element impedes the PPM stakeholders' ability to perform proper absolute or relative evaluations of PCs.

A second outstanding challenge is managers' inability to systematically incorporate EDR-related data into portfolio balancing criteria that are used to determine the mix of PCs with the greatest potential to collectively support the organizational strategy. For example, organizations often need to define and control strategic corporate guidelines related to the EDR-related data, such as the desired level of an alliance with an external vendor, or the appropriate outsourcing of a certain organizational competency. This limits the analysis of the organizational project portfolio from comprehensively reviewing how well the portfolio implements the corporate strategy.

A third existing challenge faced by organizations is the inability of current PPM methods to configure a centralized framework for management of EDR-related events and inferred situations through such means as a complex (composite) rules engine that incorporates desired business rules. Such engines are capable of inferring or deducing that a certain situation has occurred based on one or more events and performing a pre-defined action. For example, organizations may need to infer situations where a PPM initiative is performing poorly yet the organizational activities that depend on it continue to increase. Conversely, organizations may need to recognize situations in which a department appears to become much less cooperative providing services to PPM while key PPM initiatives increase their dependency on it. This limitation significantly slows down the organization's responsiveness to important PPM-related events and impedes the quality of actions taken in response to these events and inferred situations.

A fourth challenge is the inability of current PPM methods to establish a structured framework for attribute and process lifecycle management for different types of EDs associated with the project portfolio. These lifecycle processes may include communication management, change management, risk management, issue management, or even a structured process for imposition of an ED on a PC set externally to the influenced PC. An example scenario would occur when a company decides to temporarily freeze all new development projects and needs a framework for approving, communicating, and imposing such an ED on all the PCs influenced by it. In addition, EAs that depend or impose EDs on PCs may also need to be associated with an owner parent entity, such as an organizational department, that is ultimately responsible for its activities. Each such parent entity may have a different set of framework requirements, which may need to be integrated with the frameworks of their EAs. Finally, specific EDRs may require their own lifecycle processes, as in a situation where an EA is based on an agreed contract between two parties. These limitations result in lack of proper accountability and control mechanisms, deviation from desired organizational behaviors, and wastage of resources.

A fifth challenge relates to limitations of metric assessment tools surrounding the planned, active, historical or hypothetical EDR-related data. One such limitation is the inability of current PPM systems to evaluate the degree of coupling among PCs or between PCs and activities external to projects in a managed portfolio. Different measures of coupling between entities—a well-established concept in the fields of statistics and software engineering—may apply to PPM such as content coupling when one entity relies on the internal workings of another or external coupling when two entities are influenced by the same external activity. The lack of this capability in current systems leads to several problems. First, indirect external dependencies cannot be easily identified, which leads to serious execution problems that are often mishandled without the knowledge of where the emphasis should be put. Second, PCs are often miscategorized since complete lists of their EDs—which are essential to proper grouping—are unavailable. Third, without this analysis, the interdependencies among organizational departments and other entities that are responsible for managing EAs cannot be properly managed leading to an inaccurate allocation of resources, organizational design problems, etc.

A sixth challenge relates to the inability of existing PPM methods to effectively define, detect, warn or prevent creation of interdependency scenarios among PCs or between PCs and PPM-external EAs that create challenging or impossible situations. Such scenarios include indirect cyclical references involving EAs that are PPM-external; long chains of dependencies imposed on a specific task; excessive number of different dependencies imposed on the same activity making it hard to complete it; or an excessive dependency of key activities on a single EA or its parent organization making it an organizational “bottleneck”.

### SUMMARY

The present invention applies concepts from the graph theory in mathematics and computer science to the management of external dependencies associated with a project portfolio. By viewing components of a project portfolio as nodes (vertices) of a graph, which may also include activities that are external to the project portfolio but depend or impose dependencies on it, a significant and unique business value can be realized. An exemplary embodiment of these concepts is described, demonstrating comprehensive, generic, and flexible system and methods.

According to a first aspect of the present invention there is provided a computerized method of simultaneously imposing global external dependency relationships on one or more dependent portfolio components set by an external entity to said dependent portfolio component in a project portfolio management computer application, thus enabling rapid and broad adjustment of said portfolio components to external conditions affecting said portfolio components, comprising: creating the external entity and inputting its attributes; defining zero or more filter criteria for selecting the dependent portfolio components; selecting the dependent portfolio components according to said defined filter criteria; defining one or more attributes of the external dependency relationships; executing a series of programming commands representing the impact of said external dependency relationships on the selected dependent portfolio components; and displaying said external dependency relationships.

According to a second aspect of the present invention there is provided a computerized system for project portfolio management operative for simultaneous imposition of global external dependency relationships on one or more dependent portfolio components set by an external entity to said dependent portfolio component, thus enabling rapid and broad adjustment of said portfolio components to external conditions affecting said portfolio components, comprising: user interface means adapted for creating said external entity and inputting its attributes, defining zero or more filter criteria for selecting said dependent portfolio components, selecting said dependent portfolio components according to said defined filter criteria, and defining one or more attributes of said external dependency relationships; memory means connected with said user interface means, said memory means adapted to store said external dependency relationships attributes of at an adjacent series of addresses; processor connected with said memory means, said processor programmed to execute a series of programming commands representing the impact of said external dependency relationships on said selected dependent portfolio components; and display means operatively connected with said memory means for displaying said external dependency relationships.

According to a third aspect of the present invention there is provided a computerized system for project portfolio management operative for systematically and repeatedly incorporating external dependency relationships data into the numeric assessment scoring mechanisms of portfolio components, such that a comprehensive assessment of said portfolio components can be performed and said portfolio components can be consistently and objectively evaluated against each other while accounting for said external dependency relationships data, comprising: user interface means adapted for defining one or more automated rules by which said external dependency relationships integrate with said assessment scoring mechanism of said portfolio components; a processor connected with said user interface means, said processor comprising a programmed assessment scoring mechanism adapted to calculate assessment scores of said portfolio components based on said rules and said external dependency relationships of said portfolio components; memory means connected with said processor; and display means operatively connected with said memory means for displaying said calculated assessment scores of said portfolio components.

According to a fourth aspect of the present invention there is provided a computerized method for systematically and repeatedly incorporating external dependency relationships data into the numeric assessment scoring mechanisms of portfolio components in a project portfolio management system, such that a comprehensive assessment of said portfolio components can be performed and said portfolio components can be consistently and objectively evaluated against each other while accounting for said external dependency relationships data, comprising: defining one or more rules by which said external dependency relationships integrate with said assessment scoring mechanism of said portfolio components; creating said portfolio components and their said external dependencies relationships data; calculating assessment scores of said portfolio components based on said rules and said external dependency relationships of said portfolio components; and displaying said calculated assessment scores of said portfolio components.

According to a fifth aspect of the present invention there is provided a computerized system for project portfolio management operative for management of a plurality of custom entity types capable of depending or imposing external dependency relationships on portfolio components, and establishing flexible, structured, and automated business rules surrounding said external dependency relationships, comprising: first user interface means adapted for defining one or more external entity types representing classes of entities capable of depending or imposing said external dependency relationships on other said entities, whereas said external entity types may be portfolio components or non-portfolio components entities; said first user interface further comprising means adapted for defining settings, attributes and lifecycle processes of said external entity types affecting said entities upon involvement in said external dependency relationships under zero or more conditions; second user interface means adapted for creation of a plurality of said external dependency relationships for said entities associated with said external entity types; memory means connected with said first and second user interface means, said memory means adapted to store said attributes, said settings and said lifecycle processes of said external entity types and said external dependency relationships; processor connected with said memory means, said processor programmed to command said memory means to store data of said external entity types and said external dependency relationships, identify occurrence of said conditions, and apply said settings, said attributes, and said lifecycle processes upon involvement of said entities in said external dependency relationships; and display means operatively connected with said memory means, said display means adapted for displaying said external dependency relationships and their effect by said settings, said attributes, and said lifecycle processes of said external entity types associated with them.

According to a sixth aspect of the present invention there is provided a computerized method of management of a plurality of custom entity types capable of depending or imposing external dependency relationships on portfolio components, and establishing flexible, structured, and automated business rules surrounding said external dependency relationships in a project portfolio management computer application, comprising: defining one or more external entity types representing classes of entities capable of depending or imposing external dependency relationships on other said entities, whereas said external entity types may be portfolio components or non-portfolio components entities; defining one or more settings, attributes, or lifecycle processes associated with said external entity types and affecting said external dependency relationships under zero or more conditions; creating a plurality of said external dependency relationships associated with said external entity types; and displaying said external dependency relationships affected by said settings, said, attributes, and said lifecycle processes of their associated said external entity types.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1A, 1B, 1C depict several concepts and core design elements that are fundamental to an understanding of the present invention and its exemplary embodiment;

FIG. 2 depicts the present invention's functional units in an exemplary embodiment; and

FIG. 3 illustrates a “portfolio dependency map”, which is one of the outputs of the invention.

### DETAILED DESCRIPTION

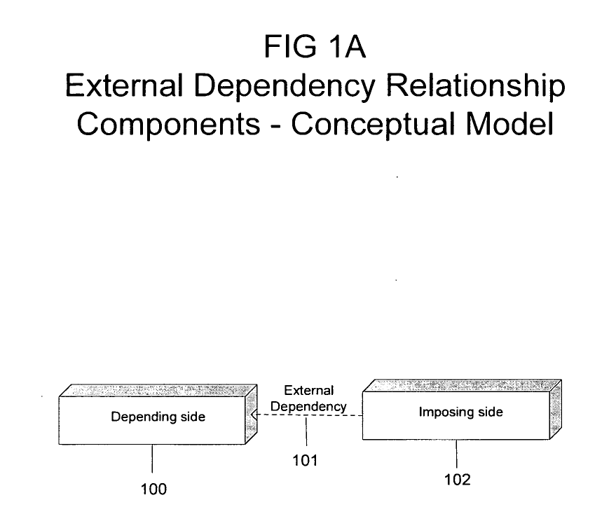

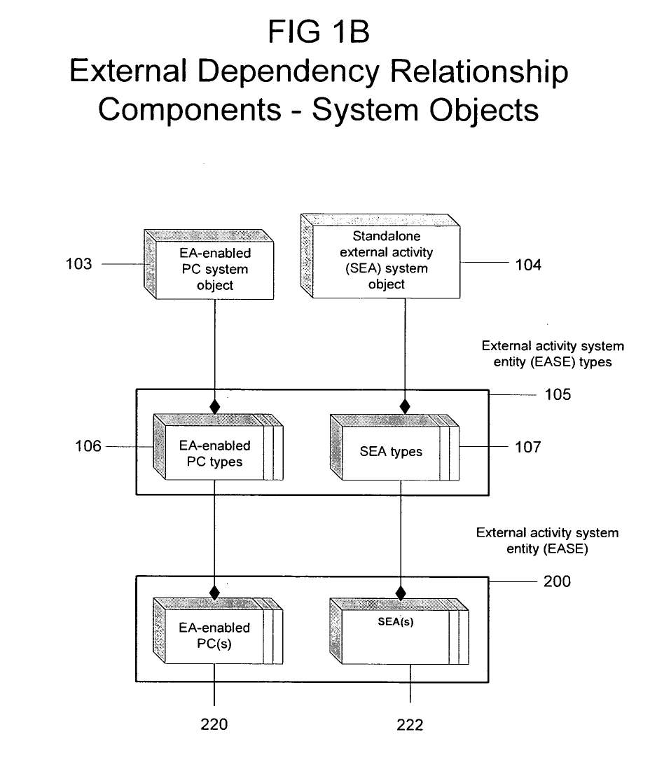

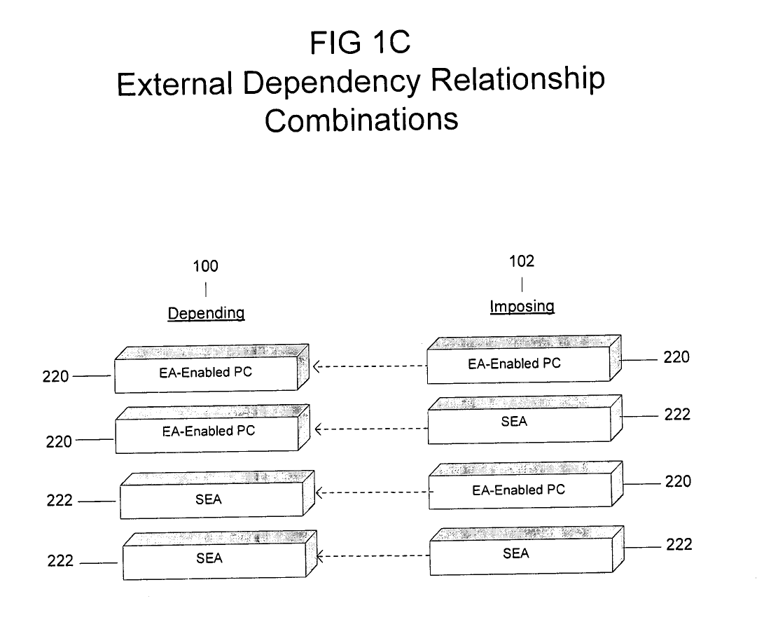

FIGS. 1A, 1B, and 10 illustrate several concepts and core design elements that are fundamental to an understanding of the present invention and its exemplary embodiment.

The present invention applies concepts from the graph theory in mathematics and computer science to the management of EDs associated with a project portfolio. A graph is an abstract representation of a set of objects where some pairs of the objects are connected by links. The graph used by this invention is a directed graph containing the following:
a) A set of elements, called vertices.
b) A set of ordered pairs of vertices, called directed edges or arcs. An arc a=(x,y) is considered to be directed from x to y; y is called the head and x is called the tail of the arc.

The following list outlines additional attributes of the present invention's graph:
a) It is a multigraph, where any pair of vertices may be connected by more than one edge.
b) Loops are not permitted. A loop is an edge which starts and ends at the same is vertex.
c) The vertices of a graph, by their nature as elements of a set, are each uniquely distinguishable, or vertex-labeled.
d) A vertex may exist in a graph and not belong to an edge.

In the present invention, tails represent external activities (EAs) which influence one or more other activities, directed edges represent external dependencies (EDs), and heads represent activities influenced by EAs. A tail is referred to as the imposing side of an external dependency relationship; the head is the depending side; and the ED connects them. FIG. 1A depicts these 3 elements of EDRs:
a) The depending side (100) is influenced by the imposing side (102). The activity represented by the imposing side (102) is not considered an integral part of the depending side's (100) activities, hence is an EA to it, and vice versa.
b) The imposing side (102) influences the depending side (100)
c) ED (101), the influence of the imposing side (102) on the depending side (100). For example, certain parts of the activities represented by the depending side (100) cannot be completed until certain parts of the activities represented by the imposing side (102) have been completed

FIG. 1B depicts building blocks of EDRs in an exemplary embodiment. There are two types of system objects which may be configured to serve as the depending or imposing sides of EDRs:
a) EA-enabled PC system object (103).
b) Standalone external activity (SEA) system object (104), which represents activities that are not considered PCs in the PPM system that contains the embodiment.

System administrators will be able to create one or more instances of each such system objects, referred to together as external activity system entity (EASE) types (105). Therefore, the total number of EASE types (105) in the system will be equal to the sum of the number of EA-enabled PC types (106) and SEA types (107). Each EASE type (105) represents a distinct combination of a specific type of EA and its ability to either depend on EAs or impose EDs. Several examples of EASE types (105) include an “imposing project task”, a “depending program”, or an “imposing government decision”. Each imposing or depending side of any EDR will be associated with a single EASE type (105) and be referred to as an EASE (200). Throughout this patent, the depending and imposing sides of EDRs will either be generically referred to as EASEs (200) or as SEAs (222) and EA-enabled PCs (220), based on the identity of their associated system object (103 or 104), when such level of granularity is necessary.

FIG. 1C depicts possible combinations of EASEs that may serve as the depending (100) and imposing (102) sides of an EDR:

a) An EA-enabled PC (220) may depend on another EA-enabled PC (220).

b) An EA-enabled PC (220) may depend on a SEA (222).

c) A SEA (222) may depend on an EA-enabled PC (220).

d) A SEA (222) may depend on another SEA (222).

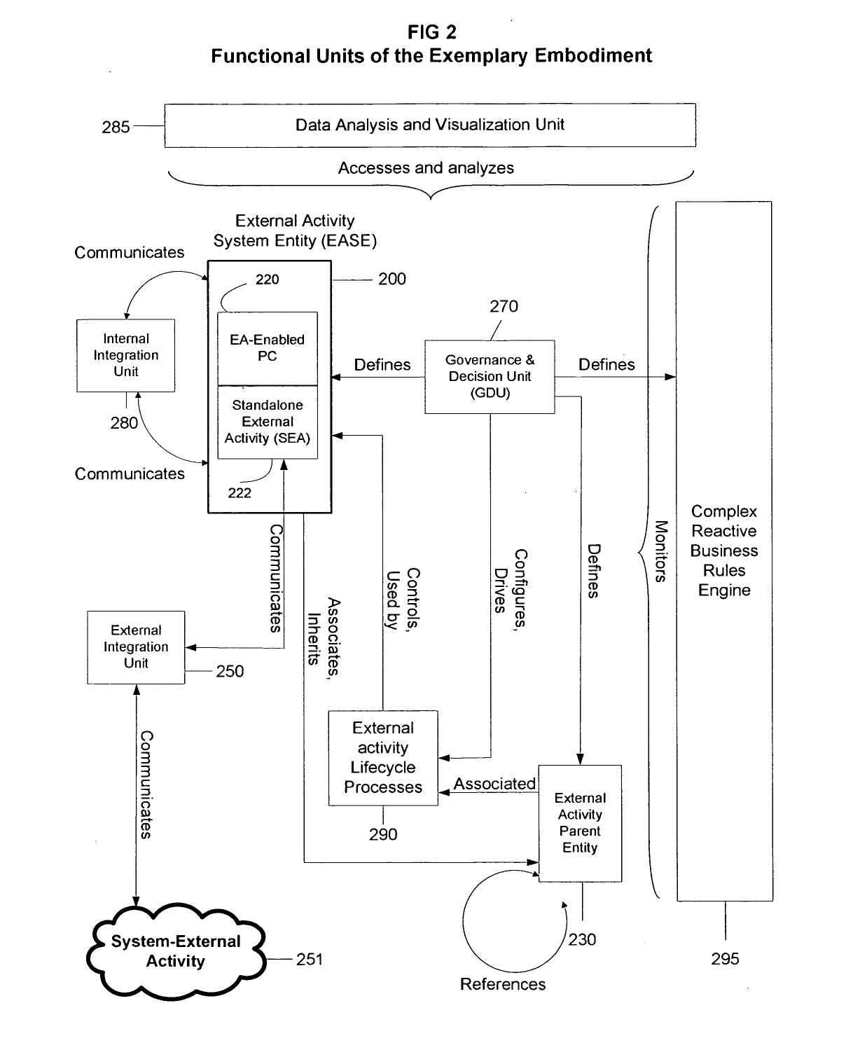

FIG. 2 depicts the present invention's functional units and their relationships in an exemplary embodiment. These units represent a logical grouping of the invention's capabilities based on their functionality, and does not necessarily represent independent technical components. In this exemplary embodiment, EDR management capabilities are integrated into a commercial PPM tool, which typically contains many more functional units. Only functional units that are relevant for an understanding of the present invention are included. Due to the number of functional units involved and the numerous capabilities of each one, this section will begin with a summary section that provides a general understanding of the embodiment's architecture, followed by a

### DETAILED DESCRIPTION

Every EDR in the system involves a depending and an imposing EASE (200), which are represented in the system as EA-enabled PCs (220) or SEA entities (222). The internal integration unit (280) enables the establishment and management of EDRs by brokering between the depending and imposing EASEs (200) and providing critical EDR-related services to each side. Since SEAs (222) may also represent data that is external to the PPM system, the external integration unit (250) enables creation and management of EDRs between EASE(s) (200) and system-external activities (251). EA lifecycle processes (290) dictate structured EDR-related processes that users of the embodiment should follow, such as risk management or issue management.

Each EASE (200) type may be associated with an external activity parent entity (230) representing an inter or extra-organizational entity that needs to be independently managed by the organization. The system will allow configuration of one or more EA parent entities (230), each with a possibly different set of data attributes, settings, and lifecycle processes which may be inherited by its EASE (200) type (s).

The governance and decision unit (270) can be configured to store and enforce a decision-making framework and other governing rules surrounding management of EDRs in the system. The complex reactive rules engine (RE) (295) detects and reacts to multiple incoming events and processes event patterns based on user-configured rules by accessing and analyzing data of all the other functional units. The data analysis and visualization unit (285) analyzes and visualizes data from all the other functional units.

These functional units are technically implemented through multiple software components that exchange information frequently. These components may run independently on multiple, separate computers. In a preferred embodiment, components which run on different computers will communicate via standard computer networking software that exchanges information over standard computer networking equipment. The software and equipment will use standard mechanisms to securely protect access to the information as needed. Information that is only needed locally within a component may be stored locally. Information that must be shared with other components will be shared via standard client-server protocols—such are widely used on the Internet—and stored at servers. Components will act a clients or servers to retrieve such information as necessary. Alternative implementations may employ database servers or web services or web servers or other commonly used server technologies to enable the exchange of information between components. A computer programmer skilled in the art may select one or more of these technologies as an appropriate communications infrastructure to support the exchange of information among the components of this invention. In addition, several functional units require a graphical user interface (GUI) which may be developed through widely spread programming languages supporting the development of end user screens such as Sun Java® or Microsoft® C#. As mentioned earlier, in the exemplary embodiment EDR management capabilities are integrated into a commercial PPM tool. Therefore, technical decisions such as which programming languages or communication protocols to employ should be influenced by the existing technology used by the commercial. PPM tool. Each of these functional units will now be described in greater detail.

External Activity System Entities (EASE) (200)—As mentioned as part of the description of FIG. 1, there are two types of system entities supporting the EA functionality—EA-enabled PCs (220) and SEAs (222). EA-enabled PCs (220) represent typical work units of an organizational project portfolio enabled to support the EA functionality. Typical PC types in PPM systems include the following:
a) Idea—proposal of a new project, program, or initiative.
b) Work package—“A deliverable or project work component at the lowest level of each branch of the work breakdown structure” (A guide to the project management body of knowledge—3rd edition, Project Management Institute, 2004).
c) Task—Term for work within a structured plan for project work. Tasks typically represent work packages, but sometimes represent a larger work unit that consists of more than one work package.
d) Project—Collection of tasks aimed at producing a unique product or service.
e) Sub-project—Group of one or more project tasks that are typically logically related.
f) Stage—Segments of a project with key decision points.
g) Program—Collection of one or more projects that are logically related.

h) Initiative—Collection of one or more programs that are logically related.
i) Sub-portfolio—“A collection of components which includes programs, projects, portfolios, and other work grouped together within a larger portfolio” (A guide to the project management body of knowledge—3rd edition, Project Management Institute, 2004).
j) Portfolio—Collection of projects and/or programs that are grouped together.
k) Risk/issue/scope changes—Control processes associated with other PCs which may generate unplanned work.

Conceptually, all typical PC types of PPM systems, as defined above, may impose EDs, depend on EAs, or both. Nevertheless, organizations may selectively decide to only enable this functionality for certain PC types and the present invention will allow for such flexibility. Each EA-enabled PC (220) type may be configured to have a unique set of attributes, settings, processes, and privileges.

SEAs (222) are system entities representing activities that depend or impose EDs on EA-enabled PCs (220)—directly or indirectly—yet are not considered PC activities in the PPM system that contains the present embodiment. Organizations will be able to create multiple SEA (222) types, each with a possibly different set of attributes, settings, processes, and privileges. Different SEA (222) types will typically represent activities of different natures, such as imposing government decisions or product shipments, yet organizations may decide to have SEA (222) types represent different classifications. Every SEA (222) created in the system will be associated with a single type, inherit its properties, and represent a single instance of its type.

A SEA (222) may be initially created without an association to its depending/imposing EASE(s) (200) and later associated with this/these entity (ies). With respect to the graph model, these are represented by vertices that are not connected by edges. For example, an influential executive decision can be made and believed to be imposing an ED on multiple EA-enabled PCs (220), while it is initially unclear specifically on which ones. A SEA (222) may then be created to represent the decision without any association to specific EA-enabled PCs (220), which could be defined later.

SEAs (222) may also represent data that is external to the PPM system, such as content of web page on the world-wide-web/corporate intranet or the status of a record in an external information system. This functionality, which is considered optional to development of the present invention, is described in the “external integration unit” section.

In order to enable users to use the present embodiment in a PPM system that contains it, different decisions and corresponding configurations and settings need to be defined. Some of these may only be defined at one specific location (level) within the system, while others may be defined at more than one location. The GDU (270) enables the system administrator to define the order of precedence according to which the system determines its behavior in cases where the same setting has been defined at more than one level. The following list outlines the different levels of the present embodiment supporting definition of settings in support of the invention's functionality:
a) System-wide level—May apply to all system scenarios involving the setting or configuration.
b) Sub-portfolio or portfolio levels—May apply to all EA-enabled PCs (220) that belong to a certain sub-portfolio or portfolio.
c) EA-parent entity level (230)—May apply to all EASE (200) types associated with the EA-parent entity (230). For example, if organizations configure an EA-parent entity (230) representing the government then certain attributes, such as the firm's government liaison, may be inherited by all the EASE (200) types associated with it.
d) EASE (200) type level—May apply to all EASEs (200) or related entities that control their settings created based on the EASE (200) type. For example, an attribute of the EASE (200) type “imposing task” may be inherited by actual imposing project tasks or the projects they belong to.
e) Individual EASE (200) level, the entity it belongs to, or a related entity that controls its settings—For example, organizations may decide to enable the EA functionality for project tasks and then have project managers make certain decisions related to the way EAs imposed or depend on their project tasks be handled.
f) Individual EDR level—For example, in cases where the EDR represents a unique agreement between two parties, it may include properties that are specific to it.

These different decisions and corresponding settings include the following:
a) Determine the number and identity of SEA (222) types to create. For example, a given organization may decide to create two types of SEAs, one representing a FDA approval and the other representing an executive decision that is not part of standard PPM processes.
b) Determine the PC types for which to enable the EA functionality. For example, organizations may decide to enable the EA functionality for projects, project tasks, and programs.
c) For each of the items defined in the first two points, determine whether it should be allowed to depend on EAs, impose EDs or both. In other words, determined all the system's EASE (200) types as defined as part of FIG. 1's description.
d) Determine whether different EASE (200) types should be associated with an EA parent entity (230). For example, a SEA (222) type representing an imposing FDA decision may be associated with an EA parent entity (230) representing the government. As described in the “EA parent entity” section, child EASE (200) types may inherit properties from their parent entities. These first 4 settings are defined at a system (global) level.
e) Define the conditions under which EASEs (200) may be the imposing or depending side of an EDR. For example, organizations may decide that project tasks may depend on external projects that are in status “planned” or “active” either as a discretionary (soft-logic) or a mandatory (hard-logic) dependency.
f) Define data attributes of EASEs (200) that get enabled upon creation EDRs and their properties, under different conditions. Some attributes may only be visible to the depending and/or imposing sides of an EDR while others may be visible to both sides and automatically synchronize. Users or system administrators will also be able to define a formula to be applied on the exchanged data to account for such cases as special effort or cost calculations.
   One example attribute that is likely to be used across different EASE types is a communication exchange control capable of enabling communication exchanges between representative(s) of the imposing and the depending sides of an EDR. Other example attributes include: status, planned/actual start/end dates, planned/actual effort, planned/actual cost, cost tolerance, and time tolerance.
g) Determine the influence of EDRs on both the depending or imposing EASE (200) or the entity (ies) they belong to, under different conditions. For example, when a project task has a mandatory “finish to finish” dependency on an external project task then the influence on the dependent task might be that its status cannot be set to “completed” until the status of the imposing task is set “completed” as well. A second example is when the resources used by an EA imposed on an EASE (200) need to be accounted for and rolled up into the EASE's (200) resource metrics.
   EASEs (200) that are imposed or depend on EA-enabled PCs (220) may also influence the evaluation of the latter in several ways. Governing rules may be created in order to define and enable the specific influence of the EASEs (200) on EA-enabled PCs (220):
      1) PC priority—Governing rules may be configured around EA-enabled PCs (220) priority rules that typically support this metric, such as proposals. For example, the system may be used to configure a “priority” attribute and make it a part of SEA (222) types representing organizational activities that depend on PPM. The value of this attribute can then influence the priority of dependent EA-enabled PCs through a defined formula.
      2) PC complexity—Governing rules may be configured around EA-enabled PCs (220) complexity evaluation rules that typically support this metric, such as projects. For example, a simple governing rule could be defined as: “If a project depends on an EA of type X, define its complexity level as ‘high’”.
      3) Risk assessment rules—One or more condition(s) determining the integration of EDR-related data with risk assessment of EA-enabled PCs (220) that typically support this metric, such as project proposals or the portfolio as a whole may be determined. For example, PPM systems that use a scoring key to determine the risk of project proposals typically have “external dependencies” risk as one of the scoring key elements. A simple governing rule could be defined as “If an EA-enabled PC (220) depends on more than 5 EASEs (200), automatically set the value of the ‘external dependencies’ risk to ‘high’”.
      4) Value assessment rules—One or more condition(s) determining the integration of the EDR-related data with value assessment of EA-enabled PCs (220) that typically support this metric, such as project proposals or the portfolio as a whole, may be determined. For example, PPM systems that use a scoring key to determine the value of EA-enabled PCs (220) may have “competitive advantage” as one of the scoring key elements. The following simple governing rule could be defined in a scenario when a company has exclusive access to certain vendors which gain it a competitive advantage: “If the EA-enabled PC (220) uses one or more exclusive vendors, set the value of the ‘competitive advantage’ value item to ‘high’.
      5) PC health integration rules—governing rules may be configured around the integration between the status of an imposing EASE (200) and one or more health metric ratings of the EA-enable PC(s) (220) it is imposed on. For example, one such simple rule could be: “If the dependent cost of an imposing EASE (200) is greater than $1 M and it is late, set the risk health rating of its dependent EA-enabled PC (220) to ‘red’”.
      Some of the EA-enabled PCs (220) evaluation metrics specified above may use weight-based numeric scoring mechanism to evaluate the entities. In those situations, the EDR governing rules could be integrated into existing scoring routines by including a sub-routine that queries the database, pulls the EDR data associated with the EA-enabled PC (220), processes it based on the governing rule definitions, incorporates the result into the overall score, and displays the output. These sub-routines could be triggered by such means as database triggers, scheduled operating system services, or manual invocation by a system user.
      Other EA-enabled PCs (220) evaluation metrics may be condition based and follow the pattern of: “If the EDR data associated with the EA-enabled PC (220) meets a certain condition(s), set the value of the evaluation metric to X”. Technically, these governing rules could operate by a sub-routine that queries the database, pulls the EDR data associated with the EA-enabled PC (220), compares it to the condition(s), incorporates the result into the overall result if the condition(s) is/are met, and displays the output. These sub-routines could be triggered by such means as database triggers, scheduled operating system services, or manual invocation by a system user.
h) Different EASEs (200) may have clear relationships with other entities, whether these entities are EASEs (200) themselves or not, such as a project that belongs to a program. Therefore, the influence of EASEs' (200) involvement in EDRs on their related EASEs (200) needs to be defined as well. Several examples of such possible influences include:
   1) Should the users involved in related EASEs (200) be notified upon creation of an EDR or other EDR lifecycle events?
   2) Should related EASEs (200) view details of the EDR though their user interface?
   3) Should related EASEs (200) inherit EDRs and be directly influenced by it? (e.g. if the program cannot move forward until its ED it complete, so do its projects).
   4) Should these settings apply to new related entities, created after the EDR was created?
i) Determine lifecycle processes of EDRs under different conditions, their data attributes and privileges. The section “EA lifecycle processes” provides additional information about this capability.
j) Determine privileges related to different EA-related operations, under different conditions, such as update of an EDR's attributes.
k) Define scenarios that create potentially challenging ED scenarios for EASEs (200) and determine the system's response to such events. Several examples of such challenging scenarios include:
   1) An EASE (200) that depends on an excessive number of EAs, making it hard to complete it.
   2) An EASE (200) that has a large number of EAs depending on it, possibly making it an organizational “bottleneck”.
   3) An EASE (200) that depends on a chain of dependencies, making it hard to complete.
l) Optionally, determine additional business rules to be executed in response to certain events and inferred situations related to lifecycle events of EASEs (200), under various conditions, as described in the “Complex reactive business rules engine” section.

These EASE (200) settings coupled with actual EDR involvement may influence EASEs' (200) data items and/or append new ones. For example, an EA-enabled PC (220) of type project may be influenced the following way:
a) Communication between the project representative(s) and the EA representative (s) may be captured together with the project interface.
b) Project scheduling may be influenced by the scheduling of its ED(s).
c) Project cost calculations may be influenced by the costs of its ED(s).
d) Project effort calculations may be influenced by the effort of its ED(s).
e) Project health metrics may be influenced by the status of its ED(s).

The following list summarizes the descriptive attributes of ED and EDRs supported by the system:
a) Internally or externally imposed—An EDR may be created through a user interface of the depending side, such as a project manager defining EDR(s) influencing his/her project, defined here as “internally imposed EDR”. Alternatively, an EDR could be imposed on one or more EASEs (200) through a user interface representing the imposing side, such as a scenario where the imposing side of an EDR is an executive decision influencing all active projects in the system. In the present embodiment, the method of creating externally imposed EDR includes the following steps:
   1) The user creates the EASE (200) representing the imposing side of the EDR. The user interface of the imposing EASE (200) contains an “external dependencies” tab, which the user activates in order to define the EDR(s).
   2) The user defines zero or more filter criteria for selecting the depending EASEs (200) such as: “All active programs in the system”, “All active projects of a certain department”, or “All project proposals supporting a specific business objective”.
   3) The system finds all the entities matching the filter criteria.
   4) The user selects specific EASE(s)(200) for which to apply the EDR, or select all the EASE(s) (200) that match the filter criteria.
   5) The user defines one or more attributes of the EDR, such as its description, probability etc.
   6) The system loops through all the dependent EASE(s) (200), calculates the impact of the EDR on each one such as impact on schedule or cost, saves this impact to the database, makes the user interface display the impact, and makes the user interface conform to the EDR's constraints.
   7) Optionally, the system may be configured to send an email notification to relevant users in response to certain events associated with the externally imposed EDR, such as its creation, deletion, or change. Technically, such events could be detected through the use of database triggers since those events could correlate with creation, update, and deletion of database records. The email notifications may be sent through standard SMTP protocol used by a mail server which the system has access to and authorized to use for this purpose.
Similar to other EDs in the system, the settings, operations, and privileges of externally imposed EDRs is controlled by the GDU (270). For example, the GDU (270) dictates the types of entities the imposing EASE (200) may impose EDs on, the attributes of the EDRs, and the impact of the EDRs on the depending EASE(s) (200).
b) Probable or certain—An ED may be probable, such as those typically defined during project planning, or could be certain, such as during their execution. By probable, we mean that each ED has a likelihood attribute. The likelihood—or probability—is greater than or equal to 0 and less than or equal to 1 and reflects the fact that information available to the person who defines the ED does not conclusively prove that the depending end of the EDR depends on the imposing end of the EDR. The likelihood estimates the chance that the depending activity will indeed depend on the imposing activity. As a limiting case, if an ED is certain, then its likelihood is 1. The likelihood can be adjusted at any time. Furthermore, analyses of the dependency graph propagate the likelihoods and employ probability theory to make conclusions about the probability of interrelated likelihoods. Most analyses will assume that likelihoods are independent—as the term is employed in probability theory—so that, for example, if C depends on B with probability p1 and B depends on A with probability p2 then C depends on A with probability p1×p2 (where x indicates multiplication).
c) Concrete or virtual—Concrete EDs represent either probable or certain EDs. Virtual EDs may be created to represent hypothetical what-if situations. For example, a project proposal may be created and associated with a set of virtual EDs which would only become concrete EDs if and when the proposal is approved and becomes a project. In addition, virtual EDs may be created through certain tools of the data analysis and visualization unit (285) such as what-if analysis. Inputs to all analyses by the data analysis and visualization unit (285) or the RE (295) can indicate a set of virtual EDs that are assumed to be concrete.
d) Discretionary or mandatory—Discretionary EDs represent preferred logic, or soft logic. For example, a second round of testing performed by an external team before code deployment, may represent a best practice but not a mandatory one. Mandatory EDs are hard logic EDs which the depending side must be influenced by.
   Direct relationships with other functional units:
a) The GDU (270) defines EASE (200) settings, operations, and privileges.
b) EASEs (200) depend/impose EDs on other EASEs (200).
c) The internal integration unit (280) enables the establishment and management of EDRs by brokering between the depending and imposing EASEs (200) and providing (critical EDR-related services.)
d) Each EASE (200) type may be associated with an EA parent entity (240) and possibly inherit attributes, settings and EA lifecycle processes (290) from it.
e) EASE (200) types, EASEs (200), the entities they belong to, or specific EDRs may be controlled by EA lifecycle processes (290) and use them.
f) EASEs (200) of type SEA (222) may represent system-external activities (251) and communicate with the external integration unit (250) in those cases.
g) EASEs (200) are monitored by the RE (295) and can use it to produce desired functionality.
h) EDR-related data are analyzed and visualized using the data analysis and visualization unit (285).

An external activity parent entity (230) represents an inter or extra-organizational entity that may have one or more EASE (200) type(s) associated with it and needs to be independently managed by the organization. EA parent entities (230) configured by organizations will typically represent inter or extra-organizational entities that are responsible for the EASE (200) types that impose or depend on PCs, such as organizational departments or external vendors. Nevertheless, different organizations may configure EA parent entities (230) to provide different classifications of EASE (200) types.

The system will allow configuration of one or more EA parent entities (230), each with a possibly different set of data attributes, settings, and lifecycle processes. For each attribute, lifecycle process, and setting, the system will allow its creator to specify whether it should be inherited EASE (200) type(s) associated with the parent entity.

For example, an EA parent entity (230) representing an organizational department's EA impositions may be configured to have an “owner” attribute designating the name(s) of the individual(s) who are accountable for the EASEs (200) associated with the entity. The same EA parent entity (230) representing an organizational department may also have lifecycle process for approval of EDs imposed by it. Both the attribute and the lifecycle process may be defined to be inherited by its child EASE (200) types.

EA parent entities (230) may also reference other EA parent entities (230) or other system entities in order to designate functional relationships. For example, EA parent entities (230) of two departments that belong to the same division may reference each other in order to designate their shared parent organizational unit. These references can be used by different system reports.

Some PPM systems may contain system entities representing an inter or extra-organizational entities which may have one or more EASE (200) type(s) associated with them prior to installation of the present embodiment. In such cases, those pre-existing system entities may be used to group EASE (200) types, instead of the EA-parent entity (230). Nevertheless, these pre-existing system entities may not contain configurable data attributes, settings, and lifecycle processes, possibly inherited by their EASE (200) types, which thus limit some of those related capabilities.

Direct Relationships with Other Functional Units:
a) EA parent entities (230) may have one or more lifecycle processes (290) associated with them.
b) EA parent entities (230) are associated with one or more EASE (200) types that can inherit attributes, settings and lifecycle processes (290) from them.
c) EA parent entities' (230) data are analyzed and visualized using the data analysis and visualization unit (285).
d) The GDU (270) defines EA parent entity (230) settings and attributes.
e) EA parent entities (230) may also reference other EA parent entities (230) or other intra or extra-system entities.
f) EA parent entities (239) are monitored by the RE (295).

The internal integration unit (280) enables the establishment and management of EDRs by brokering between the depending and imposing EASEs (200) and providing critical EDR-related services to each side. The unit performs its roles based on the settings and configuration described in the “External Activity System Entities” section. The services enabled by the integration unit include:
a) EDR set up—handles the process of establishing an EDR between two EASEs (200).
b) Communications—handles the data transfer between the imposing and depending sides of EDRs. Several examples of such information elements include:
   1) Synchronized fields—An EDR may involve an automated synchronization of data items between the two sides on an EDR, such as activity statuses or scheduling.
   2) Direct communications—Messages sent from the imposing EASE's (200) stakeholders to the depending EASE's (200) stakeholders and vice versa.
   3) Cost/effort rollup—The planned, forecasted or actual cost and effort metrics of an imposing EASE (200) may possibly rollup and update those attributes of the depending EASE (200) and its related entities.
   4) Scheduling—Different logic may be incorporated into the scheduling of depending or imposing EASEs (200) as it relates to the EDR. For example, such logic may operate as follows: prior to making a schedule change to an imposing side's dates, the integration unit (280) will determine the influence of the change on its dependent EASEs (200), both in terms of schedule and in terms of resources and notify the imposing side's owner of the results. If a decision is made to change imposing side's dates, then the internal integration unit (280) may communicate those changes to its influenced EASEs (200) and allow their owners to accept the change and automatically reschedule the dependent activities based on the imposing side's dates. If the dependent EASE's (200) owner decides to reject the schedule change then a rejection message may be sent to the imposing side's owner and a dialog may be initiated to resolve the conflict, using the communication services provided by the internal integration unit (280). Alternatively, a change to the schedule of a dependent activity may trigger an electronic notification to its imposing EASE(s) (200). Since the EA functionality may apply to different PC (220) types, the scheduling logic described above may not be applicable to certain PC (220) types.
c) EA copy and carryover—the internal integration unit (280) will optionally enable copying of EDs in such scenarios when an EASE (200) gets copied, or when an EA-enabled PC (220) of type proposal that has virtual EDs imposed on it spawns one or more PCs upon its approval that may need to inherit its imposing EASEs (200).
d) Cyclical dependencies—the unit will detect and warn users when they attempt to establish an EDR which would cause a cycle in the dependency graph. A cyclical dependency is a logically impossible situation in which, for example, some task A depend on another task X while task X depend on—either directly or indirectly—task A. The internal integration unit (280) will detect and warn about cyclical dependencies. Direct cyclical dependencies, in which a task A depends on task B and task B depends on task A, can be detected by reviewing any existing relationship between A and B before creating an EDR between them. Indirect cyclical dependencies involve more than two tasks. The system detects them with a standard distributed cycle detection algorithm. While it is unlikely, concurrent actions by multiple users of the PPM may create one or more cycle(s) that are not detected until after the users have completed inserting their EDRs. In that case, the users will be notified and dependencies should be removed to break the cycle.
   Direct Relationships with other Functional Units:
a) The internal integration unit (280) enables the establishment and management of EDRs by brokering between the depending and imposing EASEs (200) and providing critical EDR-related services.
b) The internal integration unit (280) data are monitored by the RE (295).
c) The internal integration unit (280) data are accessed and analyzed by the data analysis and visualization unit (285).

The external integration unit (250) enables creation and management of EDRs between EASE(s) (200) and system-external activities (251). A SEA (222) entity will be created to represent each system-external activity (251) involved or possibly involved in an EDR and broker between the system-external activity (251) and the EASE (200) it imposes or depends on. The external integration unit (250) is in charge of exchanging data between system-external activities (251) and their proxy SEAs (222) while the internal integration unit (280) enables the integration between proxy SEAs (222) and their depending or imposing EASE (200).

System-external activities (251) could be stored on the world-wide-web, corporate Intranet, or an external application. Integration with activities that are external to the PPM system is an optional component of the present embodiment. In cases where this functionality is not desired, the external integration unit (250) will not exist.

This external integration unit (250) is most effectively implemented by using connections to external system-external activities (251) via communications over computer networks. Two primary activities are involved—unique identification of system-external activities (251) and exchange of information with system-external activities (251).

First, a system-external activity (251) can be uniquely identified by a descriptor like a World Wide Web URL. Descriptors that conform to URL standards will be used when they work—otherwise specialized URL-like descriptors can be created for this embodiment. For example, a specialized URL-like object could identify a decision by an executive by providing the executive's name, role and current contact information. Like World Wide Web URLs, these descriptors will have a unique canonical representation, so that all representations of a descriptor for a particular system-external activity (251) can be reliably canonicalized into a single value. The canonical values will be shared throughout the PPM system, so that dependency analysis capabilities can detect all relationships that exist with a particular system-external activity (251).

Second, the means to retrieve the current status of a system-external activity (251) and determine what information, if any, should flow across the ED between the system-external activities (251) to their proxy SEAs (222), in either direction, should be defined. The means falls into two general types: event notification and polling. In event notification the system-external activity (251) is instructed and configured to notify the PPM system that an event has transpired. Much software supports this capability. For example, an email system might be configured to notify the PPM when a certain email arrives. If a system-external activity (251) doesn't provide event notification then polling, which is less efficient, would be used. Using polling, the PPM inspects the system-external activity (251) periodically, evaluating whether its status has changed in a way that influences its depending or imposing EASE (200), or vice versa. When such a change is detected the dependent endpoint is notified, and, if no future such changes are anticipated, the polling is stopped. Finally, if information about state changes at the system-external activity (251) cannot be obtained via automated computer network communications—as in the above example of a decision by an executive—then the PPM will support business processes executed by organizational staff to obtain needed information.

Direct Relationships with Other Functional Units:
a) The external integration unit (250) communicates with SEAs (222) and system-external activities (251).
b) EA lifecycle processes (290) are monitored by the RE (295).
c) EA lifecycle processes (290) data are accessed and analyzed by the data analysis and visualization unit (285).

The governance and decision unit (GDU) (270) enables implementation of a decision-making framework and other governing rules surrounding management of EDRs in the system. The capabilities of this unit will be typically spread across different physical objects that are also used to enable PPM capabilities that go beyond ED management such as a workflow engine, user access grant management, and a user to interface for configuration of rules for a rules engine. Specifically, the GDU (270) enables users to do the following:
a) Configure EA-related settings as described in the section “External Activity System Entities” and enable execution of EA-related operations.
b) Determine the order or precedence according to which the system determines its behavior and user privileges in order to resolve situations where the same setting has been defined at more than one location (level). For example, a certain EA lifecycle process (290) workflow may be defined at an EA parent entity (230) level and a different workflow for the same process may be defined at its child EASE (200) type level.
c) Configure and execute of workflows representing the lifecycle processes (290) of EASEs (200) or EA parent entities (230).
d) Define a dynamic or fixed list of users who should be allowed to perform EA-related operations (e.g. creation, update, deletion) or be involved in other ways in EA-related processes, such as those who need to be informed or consulted at certain steps of EA. The user permissions and the scope of those permissions may be defined based on a set of one or more conditions tied to one or more system attributes. For example, the system will allow configuration of the following rule: “Allow all users who have the title of Vice President to create an EA and impose it as an ED on all the programs managed in the system”.
e) Define of rules for the RE (295) or definition of the decision-making process surrounding the same.
f) Define of rules for integration of the EDR-related data with critical PPM metrics. These rules can either automate the decision or define the decision-making framework for these integrations:
   1) EDR ranking criteria rules—Governing rules may be configured around integration between the EDR-related data and the portfolio ranking criteria. For example, a rule could be configured to determine how much weight and based on what criteria will EA-enabled PCs (220) be ranked in association with the EDR-related data.
   2) EDRs portfolio balancing criteria—Governing rules may be configured around the portfolio balancing criteria related to EDRs. Portfolio balancing is the process of determining the PC mix with the greatest potential to support the organizational strategy and includes the evaluation and management of trade-offs of objectives. For example, a portfolio-balancing criterion aimed at limiting EDR-related risk might say: “The total dependency on a single vendor shall not exceed 10% of the total cost of the portfolio”.
      Direct Relationships with Other Functional Units:
a) The GDU (270) defines EASE (200) settings, operations, and privileges.
b) The GDU (270) defines EA parent entity (240) settings and attributes.
c) The GDU (270) enables configuration and execution of workflows representing the lifecycle processes (290) of EASEs (200) or EA parent entities (230).
d) The GDU (270) is used to define rules for the RE (295).
e) The GDU's (270) data are monitored by the RE (295).
f) The GDU's (270) data are accessed and analyzed by the data analysis and visualization unit (285).

EA lifecycle processes (290) dictate structured EDR-related processes to be followed by users of the present embodiment. Several examples of such processes include:

a) Approval of imposition, release, and deletion of EDs.

a) Change management

b) Quality management

c) Risk management

d) Issue management

e) Lessons learned

However, other such processes may also be defined.

EA lifecycle processes (290) may be configured at several levels within the system:
a) Associated with EA parent entities (230) and have their child EASE (200) types possibly inherit it.
b) Associated with EASE (200) types and possibly inherited by its EASEs (200). For example, organizations may want to standardize risk management of programs that impose EDs on other entities.
c) Associated with specific EASEs (200) or the entities they belong to in cases where lifecycle process (es) do not exist at the EASE (200) type level or are overwritten by its entities. For example, a certain project manager may decide to use a risk management process for management of EAs imposed on his project that is specific to his project.
d) Created for specific EDRs. For example, an EDR representing a unique business scenario may have one of more customized lifecycle process (es) (290) associated with it.

These EA-related lifecycle processes (290) may be associated with different elements of EDRs:
a) Associated with the ED between two EASEs (200). For example, a project manager and an external vendor who owns a significant EA imposed on the project as an ED may configure a quality management process to be used by their specific EDR only.
b) Exclusively associated with either side of the EDR. For example, a project-internal quality management process may be configured to inspect the work performed by its EA vendor.

Another distinguishing factor among different EA lifecycle processes (290) is that some of them may have a set of data attributes associated with them, while others do not. For example, a risk management lifecycle process may have a set of data attributes describing the risk associated with it. Finally, some EA lifecycle processes (290) are mandatory to configure, such as the process for imposition EDs while others, such as quality or risk management, may be optional.

These workflow-based processes may contain a combination of decision steps, conditions, and execution steps and be simple one step processes or multi-step zo complex processes. Workflow conditions are used to account for different business scenarios, such as specific EDR attributes, and workflow execution steps are used to have the system perform pre-defined tasks, such as update a system entity.

PCs in PPM systems, such as projects, typically have lifecycle processes and associated data entities such as risk, issue, and change management. The relationship between these lifecycle processes and the EA lifecycle processes (290) can take different forms:
a) They may be completely separate.
b) EAs can use one or more PC's lifecycle processes (es) and/or its data entities. For example, the project's risk management process may be the process followed to manage risks associated with its EAs.
c) PC lifecycle processes may be integrated with EA lifecycle processes (290) using the RE (295) or otherwise. For example, such a rule might state: “Create a project risk if a risk was associated with any of the project's EDRs if the dependent project activity (ies) are on the critical path.”
   Direct Relationships with Other Functional Units:
a) EA lifecycle processes (290) are configured and driven by the GDU (270).
b) EA lifecycle processes (290) are used by and control EASEs (200).
c) EA lifecycle processes (290) are used by and control EA parent entities (230).
d) EA lifecycle processes (290) are monitored by the RE (295).
e) EA lifecycle processes (290) data are accessed and analyzed by the data analysis and visualization unit (285).

The complex reactive rules engine (RE) (295) detects and reacts to multiple incoming events and processes event patterns based on built-in and user-configured rules. While simple event processing capabilities are a mandatory component of the present invention, the ability to perform complex event processing is an optional component of this embodiment and need not exist in cases where a manual response to complex situation capable of being identified and handled by the RE (295) is preferred.

The RE (295) will support the popular event-condition-action structure of rule engines:
a) The event part specifies the signal that triggers the invocation of the rule.
b) The condition(s) part is a logical test that, if satisfied or evaluates to true, causes the action to be carried out.
c) The action part consists of updates or invocations on the local data.

Events that represent situations detected by the RE (295) can also be combined with other events in order to detect more complex situations. The RE (295) may employ techniques such as detection of complex patterns of many events, event correlation and abstraction, event hierarchies, and relationships between events such as causality, membership, and timing, and event-driven processes.

The RE (295) will constantly run in the background as a server service and have full access to all the system's data. It will have a graphical-user-interface used by business rule creators to flexibly define desired responses to varying business requirements. In addition, business rules which are likely to be popular may be treated as system settings and have a dedicated graphical-user-interface for their management. The business rule creators will be able to create rules with different scopes such as rules at the global system level, specific portfolio/sub-portfolio levels, EA-parent entity (230), specific EASE (200) and its controlling entities, EASE (200) type, or specific EDR.

If the PPM system which contains the present embodiment already contains such an engine or monitored by an external rules engine then it may be extended to support the present embodiment's capabilities. Otherwise, a RE (295) may be built according to the well-known principles of Complex Event Processing (CEP). In the context of PPM, the RE (295) will employ CEP to help detect and “reason about” situations that are not represented and analyzed by the standard causal antecedent relationships among components.

A PPM realizing the current embodiment would be supplied pre-configured with rules for analyzing external as well as internal events. Users will be able to modify these built-in input rules and provide their own rules, to create a custom rule-set that can analyze descriptions of events and infer global properties about EDRs. Several examples of simple EDR-related business rules include:
a) “Inform the EA-enabled PC (220) owner when an ED is externally imposed on his/her EA-enabled PC (220)”.
b) “If an EA imposed on a project exceeds its time tolerance and has over $100K of dependent cost, raise a project risk”.
c) “If a single EA influences more than 3 projects in the same program then create a program level risk”.

Several examples of complex rules that seek a combination of event patterns include:
a) “Infer situations where a project is not doing well yet the organizational activities that depend on it increase”.
b) “Infer situations where a certain department, represented in the system as an EA-parent entity (230), appears to become much less cooperative providing services to PPM while key PPM initiatives increase their dependency on it”.

Direct Relationships with Other Functional Units:
a) Rules for the engine are defined and prioritized using the GDU (270).
b) The RE (295) monitors all the other functional units and has full access to their data.
c) The data analysis and visualization unit (285) accesses and analyzes the data of the RE (295).

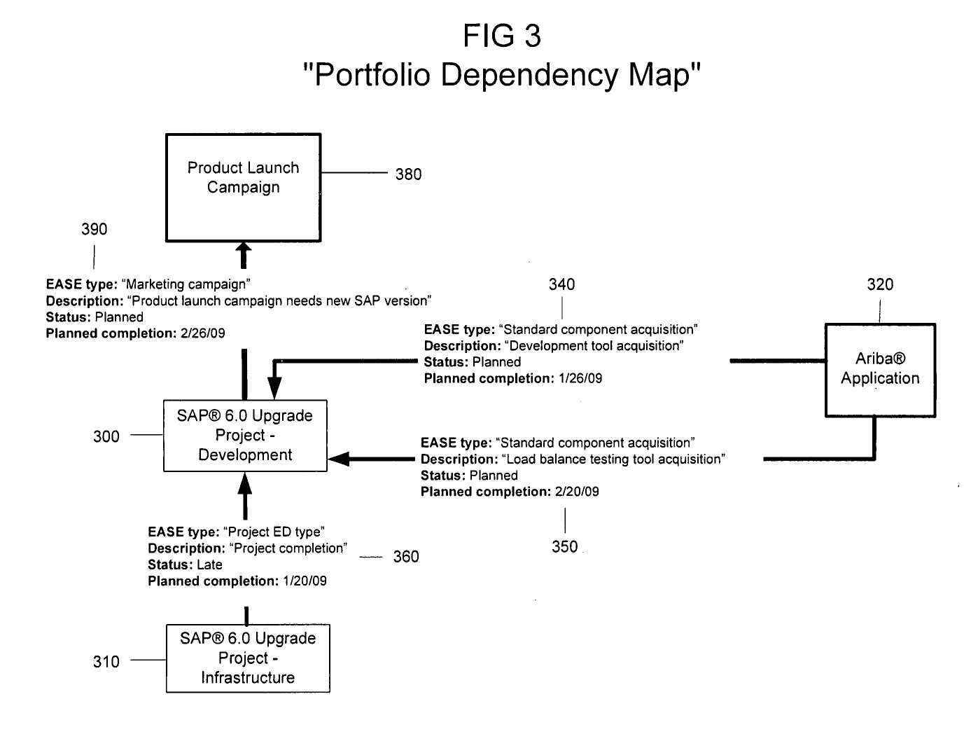

The Data analysis and visualization unit (285) analyzes and visualizes data from all the other functional units of this embodiment. In addition to standard reporting capabilities of modern information systems, it may support the following elements, all of which are optional to construction of the present embodiment:
a) What-if analysis
The what-if analysis decision-support tool allows users to simulate different EA-related scheduling situations and observe their potential impact on the portfolio. These simulations may be based on either concrete or virtual EASEs (200), and account for related entities and situations of EA dependency chains (e.g. EASE (200) A depends on EASE (200) B which depends on EASE(200) C). The results of the simulation will include a list of the PCs whose schedules and costs will be impacted by the scenario. Furthermore, the system will allow sorting and grouping of the result set based on different attributes, such as the PC type, its business objective etc.
b) Monte Carlo analysis
Unlike “what-if” analysis, which is a deterministic modeling tool using single-point estimates, probability analysis techniques such as Monte Carlo simulation use repeated random sampling of probability distribution functions as model inputs to calculate distributions of possible PC outcomes, such as costs of completion dates. For example, such techniques will be useful when the consequences of probable EDs (as defined above) cannot be solved analytically.
In this case, the consequence of any input represented by a probability or a distribution, such as, for example costs, can be propagated through the dependency graph to generate distributions for outputs, such as, for example final costs, and completion dates of PCs' EAs. Monte Carlo simulation methods have been applied to many other fields, and those skilled in the art of computer science will be able to easily apply these well known algorithms to PPM. Monte Carlo computation algorithms tend t follow this pattern:
   1. Define a domain of possible inputs;
   2. Generate inputs randomly from said domain using a predefined probability distribution;
   3. Perform a deterministic computation using said inputs;
   4. Aggregate the results of the individual computations into the final result
c) Coupling analysis
Computer techniques may be employed to determine the degree and nature of coupling among EASEs (200) and among their EA-parent entities (230). The results of these analyses could be used to support different capabilities, for example:
   1) Discover indirect dependencies among EASEs (200).
   2) Categorize PCs based on the EDRs they are involved in.
   3) Understand and manage the interdependencies among different organizational departments and PPM activities. For example, the head of the marketing department, represented in the system as an EA parent entity (230), may meet regularly with the portfolio manager to discuss their mutual dependencies.
This reliance could be represented through different metrics, for example:
   1) Count of the dependencies among the analyzed entities, known as content coupling. These dependencies could either be direct EDs among the analyzed entities or be indirect with connecting entities.
   2) Count the number of EDs shared by two or more analyzed entities, known as external coupling.
   These analyses are performed by graph algorithms that analyze the dependency graph. For example, a set T of entities to analyze is represented by a set of nodes in the graph. Whether the entities T all depend on an entity X can be determined by examining whether all the entities in T are in the tree rooted at X. As another example, the number of EDs which all of the members of a set U of entities depend on can be determined by 1) traversing the graph from one element e of U to obtain the EDs on which e depends (the initial EDs) and then 2) traversing the graph from each other element f in X, and removing EDs from the initial EDs on which f does not depend.
d) EDR scenarios watch-list
   Critical or challenging EDR-related scenarios, as defined by the users, may need to be reported on at different levels of the portfolio. Several examples include:
1) EASEs (200) that have over X amount of estimated dependent cost, whether directly or indirectly.
2) EASEs (200) that depend on an excessive number of EAs, whether directly or indirectly, making it challenging to complete them on time.
3) EASEs (200) that have a large number of EAs depending on them, possibly making them an organizational “bottleneck”.
4) Long chains of EASEs (200) which are likely to lead to execution challenges.
As above, these properties of EASEs can be determined by graph algorithms that operate on the dependency graph. In general, some property of an EASE E—such as 1) above—can be determined by defining a function on nodes in the graph—such as the sum of the cost attribute—and then traversing the graph of imposing or depending nodes reachable from E and computing the function.
e) Portfolio dependency map
The dependency map is flowchart-style representation of the EDRs among the different system entities. The detailed description of FIG. 3 below contains additional information about this tool.

Direct Relationships with Other Functional Units:
a) The data analysis and visualization unit (285) has access and analyzes the data of all the other functional units.
b) The RE (295) monitors the data analysis and visualization unit (285).

FIG. 3 illustrates an example portfolio dependency map, flowchart-style representation of the EDRs among the different system entities. It allows the user to filter the data they wish to display based on such attributes as the entity type, entity name, or the dependent amount of money. Lines are drawn among the system entities in the map to represent EDs and the user is able to select the ED attributes to display above the dependency lines. Furthermore, the portfolio dependency map allows the user to define conditional formatting for the dependency lines, based on ED attributes such as the ED status. For example, the fictitious portfolio dependency map depicted in FIG. 3 was generated with the following parameters:
a) Include EDs that are imposed on or depend upon PCs of type “projects”.
b) Include all the projects under the program “SAP® 6.0 upgrade”.
c) Display EA parent entities when available.
d) Display the following attributes on the dependency lines: “EASE type”, “description”, “ED status”, and “planned completion”.

FIG. 3 displays fictitious chart entities which were included based on the supplied parameter: “SAP® 6.0 Upgrade Project—Development” (300)—a project which belongs to the program “SAP® 6.0 upgrade” and is involved in 4 EDRs: two EDs imposed on the project (340, 350) are SEAs of type “standard component acquisition” and represented as arrows from the imposing activity—(320) representing an “Ariba” procurement system—to the depending project (300). The description attached to these arrows also displays values of different attributes as specified by the report generator. The same project (300) also imposes an ED on a SEA of type “marketing campaign” (390), representing a “product launch campaign” (380). Finally, the “SAP® 6.0 Upgrade Project—Development” (300) depends on a second project second project, “SAP® 6.0 Upgrade Project—Infrastructure” (310).

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the is scope of the present invention is defined by the appended claims and includes both combinations and subcombinations of the various features described hereinabove as well as variations and modifications thereof which would occur to persons skilled in the art upon reading the foregoing description.

1. A computerized method of simultaneously imposing global external dependency relationships on one or more dependent portfolio components set by an external entity to said dependent portfolio component in a project portfolio management computer application, thus enabling rapid and broad adjustment of said portfolio components to external conditions affecting said portfolio components, comprising:
creating said external entity and inputting its attributes;
defining zero or more filter criteria for selecting said dependent portfolio components;
selecting said dependent portfolio components according to said defined filter criteria;
defining one or more attributes of said external dependency relationships;
executing a series of programming commands representing the impact of said external dependency relationships on said selected dependent portfolio components; and
displaying said external dependency relationships.

2. The method of claim 1, additionally comprising automatically sending an electronic email notification to a predetermined set of said application users upon creation, change, or deletion of said external dependency relationships.

3. The method of claim 1 wherein said executing programming commands comprises calculating the impact of said external dependency relationships on at least one of the schedule and cost of said dependent portfolio components and presenting said impact through a user interface.

4. A computerized system for project portfolio management operative for simultaneous imposition of global external dependency relationships on one or more dependent portfolio components set by an external entity to said dependent portfolio component, thus enabling rapid and broad adjustment of said portfolio components to external conditions affecting said portfolio components, comprising:
user interface means adapted for creating said external entity and inputting its attributes, defining zero or more filter criteria for selecting said dependent portfolio components, selecting said dependent portfolio components according to said defined filter criteria, and defining one or more attributes of said external dependency relationships;
memory means connected with said user interface means, said memory means adapted to store said external dependency relationships attributes of at an adjacent series of addresses;
processor connected with said memory means, said processor programmed to execute a series of programming commands representing the impact of said external dependency relationships on said selected dependent portfolio components; and
display means operatively connected with said memory means for displaying said external dependency relationships.

5. The system of claim 4 wherein said processor programmed to automatically send an electronic email notification to a predetermined set of said system users upon creation, change, or deletion of said external dependency relationships.

6. The system of claim 4 wherein said executing programming commands comprises calculating the impact of said external dependency relationships on at least one of the scheduling and cost of said dependent portfolio components; and said display means operative for displaying said impact.

7. A computerized system for project portfolio management operative for systematically and repeatedly incorporating external dependency relationships data into the numeric assessment scoring mechanisms of portfolio components, such that a comprehensive assessment of said portfolio components can be performed and said portfolio components can be consistently and objectively evaluated against each other while accounting for said external dependency relationships data, comprising:
user interface means adapted for defining one or more automated rules by which said external dependency relationships integrate with said assessment scoring mechanism of said portfolio components; a processor connected with said user interface means, said processor comprising a programmed assessment scoring mechanism adapted to calculate assessment scores of said portfolio components based on said rules and said external dependency relationships of said portfolio components;
memory means connected with said processor; and
display means operatively connected with said memory means for displaying said calculated assessment scores of said portfolio components.

8. The system of claim 7 wherein said assessment scoring mechanism comprises means for risk assessment of said portfolio components.

9. The system of claim 7 wherein said assessment scoring mechanism comprises means for value assessment of said portfolio components.

10. The system of claim 7 wherein said assessment scoring mechanism comprises means for health evaluation of said portfolio components.

11. The system of claim 7 wherein said assessment scoring mechanism comprises means for ranking of said portfolio components.

12. The system of claim 7 wherein the said assessment scoring mechanism comprises means for complexity assessment of said portfolio components.

13. A computerized method for systematically and repeatedly incorporating external dependency relationships data into the numeric assessment scoring mechanisms of portfolio components in a project portfolo management system, such that a comprehensive assessment of said portfolio components can be performed and said portfolio components can be consistently and objectively evaluated against each other while accounting for said external dependency relationships data, comprising:
defining one or more rules by which said external dependency relationships integrate with said assessment scoring mechanism of said portfolio components;
creating said portfolio components and their said external dependencies relationships data;
calculating assessment scores of said portfolio components based on said rules and said external dependency relationships of said portfolio components; and
displaying said calculated assessment scores of said portfolio components.

14. The method of claim 13 wherein said calculating assessment scores comprises calculating risk assessment of said portfolio components.

15. The method of claim 13 wherein said calculating assessment scores comprises calculating value assessment of said portfolio components.

16. The method of claim 13 wherein said calculating assessment scores comprises calculating health evaluation of said portfolio components.

17. The method of claim 13 wherein said calculating assessment scores comprises calculating ranking of said portfolio components.

18. The method of claim 13 wherein said calculating assessment scores comprises calculating complexity assessment of said portfolio components.

19. A computerized system for project portfolio management operative for management of a plurality of custom entity types capable of depending or imposing external dependency relationships on portfolio components, and establishing flexible, structured, and automated business rules surrounding said external dependency relationships, comprising:
first user interface means adapted for defining one or more external entity types representing classes of entities capable of depending or imposing said external dependency relationships on other said entities, whereas said external entity types may be portfolio components or non-portfolio components entities; said first user interface further comprising means adapted for defining settings, attributes and lifecycle processes of said external entity types affecting said entities upon involvement in said external dependency relationships under zero or more conditions;
second user interface means adapted for creation of a plurality of said external dependency relationships for said entities associated with said external entity types;
memory means connected with said first and second user interface means, said memory means adapted to store said attributes, said settings and said lifecycle processes of said external entity types and said external dependency relationships;
processor connected with said memory means, said processor programmed to command said memory means to store data of said external entity types and said external dependency relationships, identify occurrence of said conditions, and apply said settings, said attributes, and said lifecycle processes upon involvement of said entities in said external dependency relationships; and
display means operatively connected with said memory means, said display means adapted for displaying said external dependency relationships and their effect by said settings, said attributes, and said lifecycle processes of said external entity types associated with them.

20. The system of claim 19 wherein said lifecycle processes are for approval of imposition of said external dependency relationships.

21. The system of claim 19 wherein said lifecycle processes are for approval of termination of said external dependency relationships.

22. The system of claim 19 wherein said settings apply to system privileges associated with said external dependency relationships.

23. The system of claim 19 further comprising third user interface means adapted for creation of a plurality of parent external entities representing a logical grouping of a plurality of said external entity types and enabling analysis of intra and extra organization al entity dependencies on said portfolio components of said system and vice versa; wherein said processor programmed to command said memory means to store said parent external entities; said memory means connected with said third user interface adapted to store said parent external entities; and said display means operative for displaying said grouping of said external entity types and their associated said external dependency relationships by said parent external entities.

24. The system of claim 23 wherein said third user interface means further comprising means operative for association of one or more attributes, settings, or lifecycle processes with said parent external entities affecting said external entity types grouped by said parent external entities under zero or more conditions; said processor further programmed to command said memory means to store said attributes, said settings, and said lifecycle processes of said parent external entities, identify occurrence of said conditions and apply said effect to said external entity types; said memory further comprising means adapted to store said attributes, said settings, and said lifecycle processes of said parent external entities; and said display further comprising means operative for display of said effect of said settings, said attributes, and said lifecycle processes on said external entity types.

25. The system of claim 19 wherein said second user interface means further comprising means adapted for specifying the probability of occurrence of said external dependency relationships; said processor further programmed for propagating the likelihoods of said external dependency relationships through the different entities in said system affected by them; and said display means further adapted for displaying said likelihoods of said affected entities.

26. The system of claim 19 further comprising fourth user interface means adapted for performing what-if analysis of scenarios involving said external dependency relationships; said processor programmed for calculating the effect of said external dependency relationships on the cost and schedule among entities affected by said external dependency relationships, whether directly or indirectly; and said display means adapted for displaying said calculated effect.

27. A computerized method of management of a plurality of custom entity types capable of depending or imposing external dependency relationships on portfolio components, and establishing flexible, structured, and automated business rules surrounding said external dependency relationships in a project portfolio management computer application, comprising:
defining one or more external entity types representing classes of entities capable of depending or imposing external dependency relationships on other said entities, whereas said external entity types may be portfolio components or non-portfolio components entities;
defining one or more settings, attributes, or lifecycle processes associated with said external entity types and affecting said external dependency relationships under zero or more conditions;
creating a plurality of said external dependency relationships associated with said external entity types; and
displaying said external dependency relationships affected by said settings, said, attributes, and said lifecycle processes of their associated said external entity types.

28. The method of claim 27 wherein said settings apply to system privileges associated with said external dependency relationships.

29. The system of claim 27 wherein said lifecycle processes are for approval of imposition of said external dependency relationships.

30. The system of claim 27 wherein said lifecycle processes are for approval of termination of said external dependency relationships.

31. The method of claim 27 further comprising specifying the likelihood of occurrence of said external dependency relationships; propagating the likelihoods of said external dependency relationships through the different entities in said system affected by them; and displaying said likelihoods of said affected entities.

32. The method of claim 27 further comprising performing what-if analysis of scenarios involving said external dependency relationships, comprising:
creating virtual external dependency relationships;
calculating the effect of said virtual external dependency relationships on the cost and schedule of entities affected by said virtual external dependency relationships, whether directly or indirectly; and
displaying said calculated effect.

33. The method of claim 27 further comprising visualizing said external dependency relationships, comprising:
providing a display of graphical objects representing said entities of said application involved in said external dependency relationships; and
providing a display of graphical objects connecting said entities and representing said relationships.

34. The method of claim 27 further comprising calculating the distribution of the effect of said external dependency relationships on at least one of the cost and schedule of said entities in said system, comprising:
defining a domain of possible inputs;
generating inputs randomly from said domain using a predefined probability distribution;
performing a deterministic computation using said inputs;
aggregating the results of the individual computations into the final result; and
displaying said results.

35. The method of claim 27 further comprising creating a plurality of parent external entities representing a logical grouping of a plurality of said external entity types and enabling analysis of intra and extra organizational entity dependencies on said portfolio components of said system and vice versa.

36. The method of claim 35 further comprising associating one or more attributes, settings, or lifecycle processes with said parent external entities affecting said external entity types grouped by said parent external entities and said external dependency relationships associated with said external entity types.
